(19) United States
(12) Patent Application Publication
(10) Pub. No.: US 2017/0155987 A1
(43) Pub. Date: Jun. 1, 2017

(54) SPEAKER ENCLOSURE HAVING ENHANCED ACOUSTIC PROPERTIES

(71) Applicant: Thomas & Darden, Inc., Austin, TX (US)

(72) Inventor: Russell Williamson, Austin, TX (US)

(21) Appl. No.: 15/341,960

(22) Filed: Nov. 2, 2016

Related U.S. Application Data
(60) Provisional application No. 62/387,264, filed on Dec. 23, 2015.
(60) Provisional application No. 62/250,398, filed on Nov. 3, 2015.

(51) Int. Cl. H04R 1/02; H04R 1/28

(52) U.S. Cl. CPC H04R 1/025; H04R 1/023; H04R 1/2849; H04R 3/14

(57) ABSTRACT

A speaker system may include a speaker enclosure with a front wall having an acoustic port formed therein and toward a bottom thereof, with the acoustic port being shaped such that air exiting the acoustic port flows outwards in a direction parallel to the bottom. In addition, the front wall of the speaker enclosure may be shaped so as to define a plurality of hills and valleys on an inwardly facing surface thereof. A grill may be positioned over the front wall of the speaker enclosure, the grill being shaped so as to define a plurality of valleys on an outwardly facing surface thereof, the plurality of valleys having semi-cylindrical shaped cross sections. The plurality of valleys defined by the grill may have a plurality of holes defined therein, and the plurality of holes having parabolic shaped cross sections.

### CROSS-REFERENCE TO RELATED APPLICATIONS

This application claims the benefit and priority of U.S. Provisional Patent Application, Ser. No. 62/387,264 filed Dec. 23, 2015 and titled “SPEAKER ENCLOSURE HAVING ENHANCED ACOUSTIC PROPERTIES”, as well as the benefit and priority of U.S. Provisional Patent Application, Ser. No. 62/250,398 filed Nov. 3, 2015 and titled “SELF-POWERED SPEAKER SYSTEM WITH IMPROVED PERFORMANCE CHARACTERISTICS”, the contents of both of which are hereby incorporated by reference in their entirety to the maximum extent allowable and for all purposes.

### BACKGROUND OF THE INVENTION

The present invention relates to a speaker enclosure having enhance acoustic properties and that may be used in a self-powered speaker system having improved audio, power handling, and thermal characteristics.

Small, portable devices that store audio files have come into widespread use. Some devices are dedicated to audio storage and playback. Other devices, such as smartphones, include audio storage and playback as a feature or app additional to the main function of the device. The common factor is that these devices tend to be small, and thus include small to very small speakers. Such small speakers have significant limitations in the reproduction of audio, especially music. For example, such small speakers typically have limited output volume and limited bass reproduction. Consequently, add-on, amplified speaker systems that provide improved audio reproduction have been introduced. However, while some such add-on speaker systems may provide acceptable improvements in terms of audio reproduction, those add-on speakers systems are typically unsuitable for use in an environment where they may be exposed to water. This is commercially undesirable, since a common desire for the user of such an add-on speaker system is to be able to use said add-on speaker system around a swimming pool, lake, ocean, or other body of water. While add-on speaker systems capable of performing in environments where they may be exposed to water have been developed, the audio reproduction thereof is lacking. In addition, audio reproduction itself is lacking in many portable add-on speaker systems, regardless of whether or not they are capable of performing in environments where they may be exposed to water.

Therefore, further development in the area of add-on speaker systems is necessary.

### SUMMARY OF THE INVENTION

Embodiments of the present invention provide solutions to a number of problems present in conventional wireless speaker systems. For example, a speaker system may include at least one speaker enclosure comprising a front wall having an acoustic port formed therein and toward a bottom thereof, with the acoustic port being shaped such that air exiting the acoustic port flows outwards in a direction parallel to the bottom. In addition, the front wall of the at least one speaker enclosure may be shaped so as to define a plurality of hills and valleys on a inwardly and outwardly facing surfaces thereof. A grill may be positioned over the front wall of the at least one speaker enclosure, the grill being shaped so as to define a plurality of valleys on an outwardly facing surface thereof, the plurality of valleys having semi-cylindrical shaped cross sections. The plurality of valleys defined by the grill may have a plurality of holes defined therein, and the plurality of holes having parabolic shaped cross sections.

The plurality of valleys may extend diagonally across the grill. In addition, the at least one speaker enclosure may generally be rectangular in shape, with a height and width greater than its depth. Also, the acoustic port may have a rectangular cross section.

In another aspect, a speaker system may comprise a plurality of speakers, each speaker mounted in an acoustic enclosure having acoustic foam, a storage compartment situated between the acoustic enclosures, the storage compartment having thermal insulation and a thermally insulated cover, an audio power amplifier having a plurality of channels, each channel corresponding to one of the plurality of speakers, each channel adapted to receive an analog audio signal, amplify the analog audio signal, and transmit the amplified analog audio signal to the one of the plurality of speakers, a battery adapted to provide power to the audio power amplifier, a plurality of temperature sensors, each temperature sensor associated with one of the plurality of speakers or the audio power amplifier, each temperature sensor adapted to sense a temperature of the associated one of the plurality of speakers or the audio power amplifier and transmit a signal representing the sensed temperature to control circuitry, and control circuitry adapted to receive the signal representing the sensed temperature from each of the temperature sensor and to reduce a power dissipation of a corresponding one of the plurality of speakers or the audio power amplifier.

The system may further comprise at least one connector adapted to receive an analog or digital audio signal from an external media device, and at least one connector adapted to transmit control information to an external media device. The system may further comprise at least one control device adapted to receive input from a user to generate the control information for an external media device. The system may further comprise wireless circuitry adapted to: receive an analog or digital audio signal from an external media device, and transmit control information to an external media device. The system may further comprise at least one control device adapted to receive input from a user to generate the control information for an external media device. Each of the plurality of speakers may be a two-way or three-way speaker, and the system may further comprise crossover circuitry connected between the audio power amplifier and each of the plurality of speakers. The system may further comprise a sensor adapted to detect an open and a closed position of the cover of the storage compartment and a lighting device situated in the storage compartment adapted to be illuminated when the sensor detects that the cover of the storage compartment is in the open position. 6. Each of the plurality of speakers may be at least 6 inches by 9 inches in size. Each of the acoustic enclosures may include an acoustic port providing improved bass response. The acoustic foam may comprise polyurethane foam, polyether foam, polyethylene foam, polyester foam, polyvinyl chloride foam, or melamine foam. The acoustic foam and the thermal insulation may comprise a same material.

### BRIEF DESCRIPTION OF THE DRAWINGS

FIG. 1 is an exemplary diagram of a view of an embodiment of an add-on speaker system.

FIG. 2 is an exemplary diagram of an oblique view of an embodiment of an add-on speaker system.

FIG. 3 is an exemplary block diagram of an embodiment of circuitry an add-on speaker system.

FIG. 4 is an exemplary diagram of a view of an embodiment of an add-on speaker system.

FIG. 5 is an exemplary diagram of an example of a user interface of an embodiment of an add-on speaker system.

FIG. 6 is an exemplary diagram of a view of an embodiment of a speaker mounting bracket of an embodiment of an add-on speaker system.

FIG. 7 is an exemplary diagram of a view of an embodiment of a speaker mounting bracket of an embodiment of an add-on speaker system.

FIG. 8 is an exemplary diagram of a view of an embodiment of a speaker mounting bracket of an embodiment of an add-on speaker system.

FIG. 9 is an exemplary diagram of a view of an embodiment of an acoustic port of an embodiment of an add-on speaker system.

FIG. 10 is an exemplary diagram of a view of an embodiment of a storage compartment cover hinge of an embodiment of an add-on speaker system.

FIG. 11 illustrates exemplary charts of performance testing results of an embodiment of an add-on speaker system.

### DETAILED DESCRIPTION OF THE INVENTION

Embodiments of the present invention provide solutions to a number of problems present in conventional add-on speaker systems. For example, embodiments of the present invention may provide enhanced audio performance, such as in terms of frequency response, power handling, and duration of operation of the system.

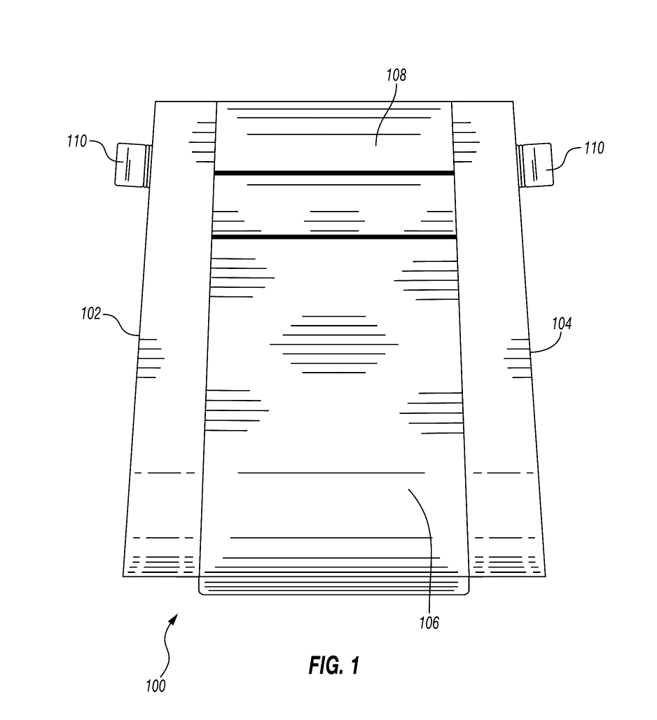

An exemplary view of one embodiment of the present invention is shown in FIG. 1. In this example, an add-on speaker system 100 is shown in a front view. System 100 includes left speaker enclosure 102, right speaker enclosure 104, storage compartment 106, storage compartment cover 108, and carrying handles 110. In this example, storage compartment cover 108 is shown in the closed position.

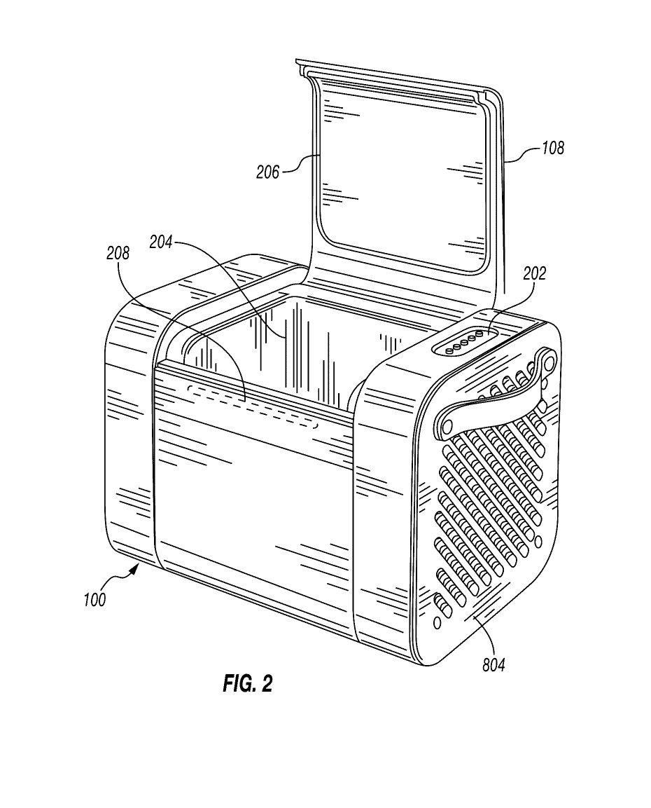

An exemplary view of one embodiment of the present invention is shown in FIG. 2. In this example, an add-on speaker system 100 is shown in an oblique view with storage compartment cover 108 in the open position. Also shown are the control panel 202, the storage compartment inner liner 204, the storage compartment cover inner seal 206, and the storage compartment light 208. In one embodiment, the storage compartment is insulated. Likewise, in one embodiment, storage compartment cover 108 may be insulated and storage compartment cover inner seal 206 may provide a significant seal, so that, when storage compartment cover 108 is closed, storage compartment cover 108 may be suitable for storing chilled or heated items, such as frozen foods, chilled beverages, cooked foods, etc. Further, in one embodiment, circuitry may determine when storage compartment cover 108 is in the open position and may illuminate storage compartment light 208 accordingly.

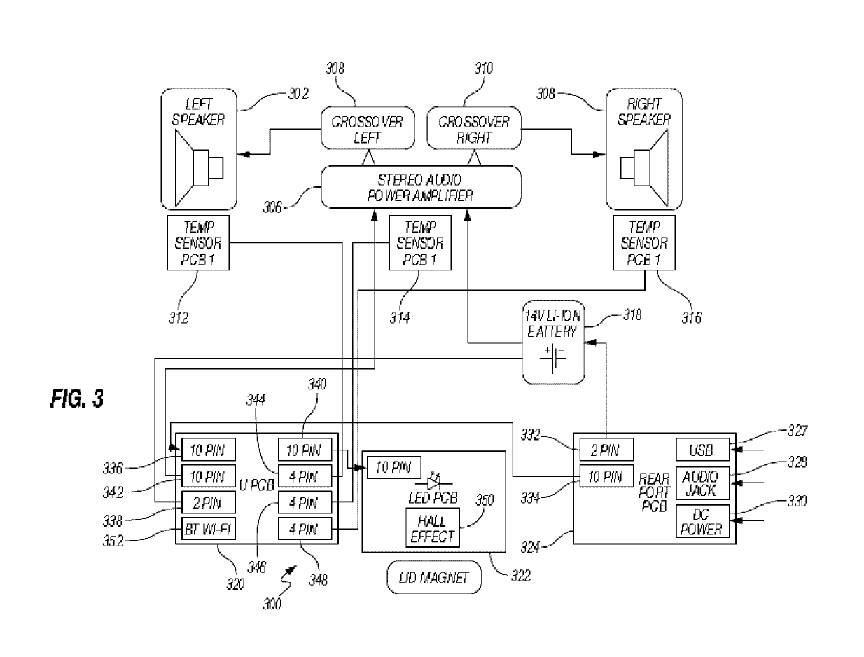

An exemplary block diagram of one embodiment of circuitry of the present invention is shown in FIG. 3. In this example, add-on speaker system circuitry 300 includes left speaker 302, right speaker 304, stereo audio power amplifier 306, left crossover 308, right crossover 310, left speaker temperature sensor 312, stereo audio power amplifier temperature sensor 314, right speaker temperature sensor 316, battery 318, user interface board 320, storage compartment light board 322, rear port board 324, and lid magnet 327.

In this example, rear port board 324 includes USB connector 326, audio connector 328, and Power connector 330. USB connector 326 may provide power and communication connection with a connected device. For example, USB connector 326 may provide up to 2.1 amps of 5 volt power to a connected device, which may be used to power the device and/or to charge a battery in the device. Likewise, USB connector 326 may communicate data, media streams, and commands with a connected device. Further, USB connector 326 may be used to receive firmware updates for the processor included in the add-on speaker system. Accordingly, at least two channels of digital audio signals may be received by the add-on speaker system via USB connector 326. Audio connector 328 may provide inputs for at least two channels of analog audio signals. Power connector 330 may provide an input for power, such as DC power from a DC wall adapter or other power source, for recharging battery 318 and/or powering system 300 directly. Connector 332 may provide power to battery 318 for recharging. Connector 334 may connect to user interface board 320 via connector 336 and may provide analog audio signals and other signals from rear port board 324.

User interface board 320 may provide user input and output functions, such as those provided by control panel 202, shown in FIG. 2. User interface board 320 may include connector 336 by which user interface board 320 may receive analog audio signals and other signals to user interface board 320. Further, user interface board 320 may receive power from battery 318 via connector 338. User interface board 320 may transmit power and control signals to storage compartment light board 322 via connector 340. User interface board 320 may transmit analog audio signals and other signals to stereo audio power amplifier 306 via connector 342. Further, user interface board 320 may receive temperature sense signals from temperature sensors 312, 314, and 316 via connectors 344, 346, and 348, respectively. In addition, user interface board 320 may include Bluetooth/Wi-Fi circuitry 352. Bluetooth/Wi-Fi circuitry 352 may provide the capability to wirelessly connect to other devices using the Bluetooth and/or the Wi-Fi wireless communication systems. Such wireless connections may provide communication capabilities such as to communicate data, media streams, and commands with a connected device. Wireless connections may be used to receive firmware updates for the processor included in the add-on speaker system. Accordingly, at least two channels of digital audio signals may be received by the add-on speaker system via wireless connections. Alternatively, Bluetooth/Wi-Fi circuitry 352 may be located on rear port board 324, in stereo audio power amplifier 306, or on a separate board (not shown).

Storage compartment light board 322 may include magnetic sensor 350, which may sense the proximity of lid magnet 327. For example, when storage compartment cover 108 is in the closed position, lid magnet 327 may be in proximity to magnetic sensor 350, which would then provide a lid closed indication. Likewise, when storage compartment cover 108 is in the open position, lid magnet 327 may not be in proximity to magnetic sensor 350, which would then provide a lid open indication. A lid open indication may be used, for example, to cause storage compartment lighting to be activated. Likewise, a lid closed indication may be used, for example, to cause storage compartment lighting to be deactivated. Magnetic sensor 350 may be any suitable magnetic sensor, such as a Hall Effect magnetic sensor. Alternatively, any other suitable sensor may be used, such as an optical sensor, a pressure sensor, a switch, etc.

Temperature sensors 312, 314, and 316 may be physically located so as to sense the temperatures of left speaker 302, stereo audio power amplifier 306, and right speaker 304, respectively. When at least one received temperature sense signal from temperature sensors 312, 314, and 316 indicates a component temperature in excess of a threshold temperature, user interface board 320 may reduce the levels of analog audio signals transmitted to stereo audio power amplifier 306 so as to reduce the power dissipation of stereo audio power amplifier 306, and/or speakers 302 and 304. If the indicated temperature is too high, user interface board 320 may cut off the analog audio signals so as to reduce the power dissipation of stereo audio power amplifier 306, and/or speakers 302 and 304 to zero or to a quiescent level.

User interface board 320 may transmit analog audio signals and other signals to stereo audio power amplifier 306 via connector 342. In this example, left speaker 302 and right speaker 304 are two-way or three-way speakers. Thus, the left output of stereo audio power amplifier 306 is connected to left speaker 302 through left crossover 308 and the right output of stereo audio power amplifier 306 is connected to right speaker 304 through right crossover 310.

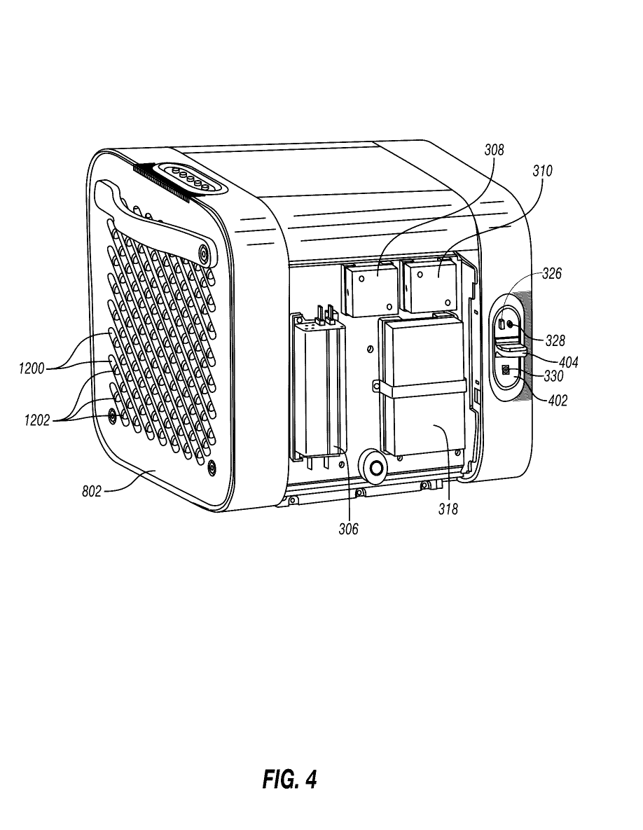

An exemplary view of one embodiment of the present invention is shown in FIG. 4. In this example, the rear port area 402 is shown with the rear port covers 404 in the open position. Rear port area 402 may include USB connector 326, audio connector 328, and power connector 330. Further in this example, a view of the back of the system enclosure is shown with a panel removed to show an example of physical placement of components, such as stereo audio power amplifier 306, left crossover 308, right crossover 310, and battery 318.

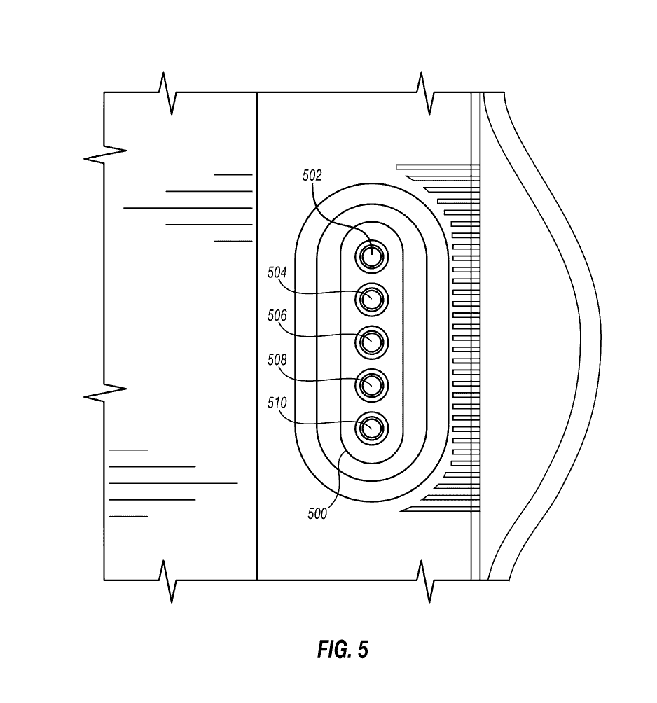

An exemplary view of one embodiment of a user interface 500 of the present invention is shown in FIG. 5. In this example, user interface 500 includes a power button 502, a Bluetooth Pairing, AirPlay Mode activate button 504, multi-function button 506, a volume increase button 508, and a volume decrease button 510. User interface 500 provides controls with which the user may control the operation of the add-on speaker system and/or an attached media player. For example, power button 502 may provide the capability to turn the add-on speaker system on and off and also may provide the capability to turn an attached media player or other device on and off. The Bluetooth Pairing, AirPlay Mode activate button 504 may provide the capability to switch Bluetooth Devices, pair a new Bluetooth device, or switch to 802.11 AirPlay mode. The next multi-function button 506 may provide the capability to cause an attached media player to Play or Pause (single quick-click), skip to the next track or media content (double-click), or skip to the previous track or media content (triple-click). Volume increase button 508 increases the playback volume and volume decrease button 510 decreases the playback volume.

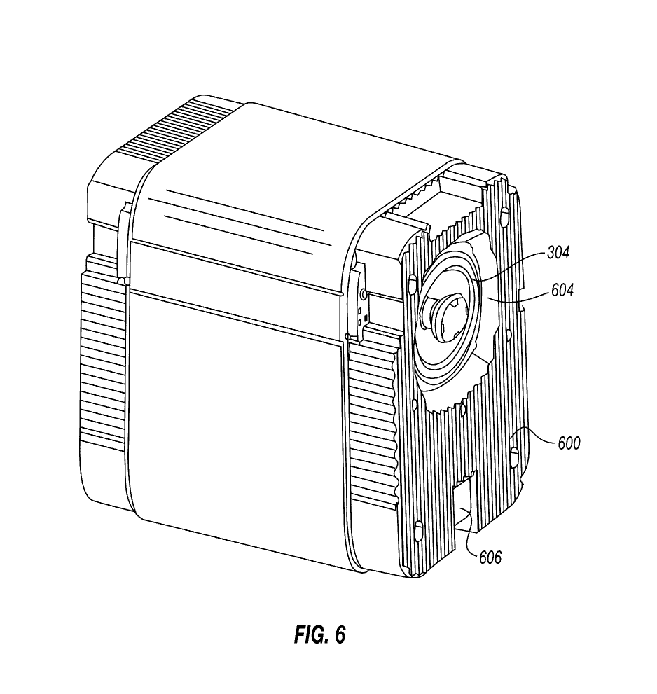

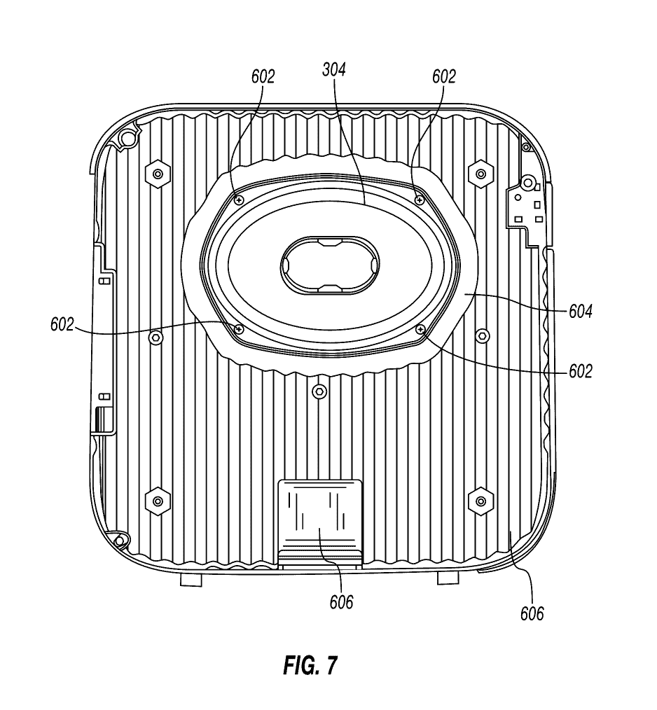

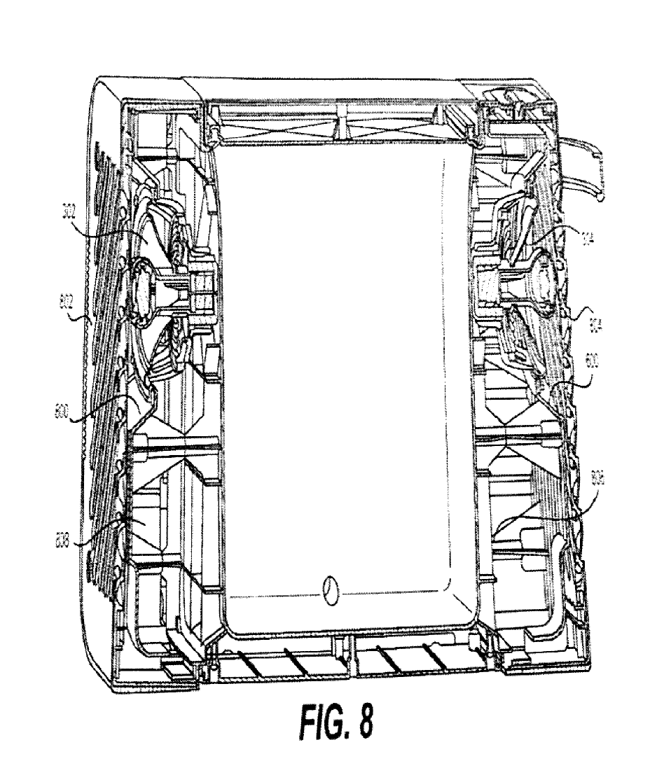

An exemplary view of one embodiment of a speaker mounting bracket of the present invention is shown in FIG. 6. In this example, a view of the right speaker mounting bracket 600 is shown. Each speaker is mounted to its respective mounting bracket. Thus, in the example shown, right speaker 304 is shown mounted to right speaker mounting bracket 600 using mounting screws 602. Each speaker mounting bracket includes a recessed portion in which the respective speaker is mounted. The recess, which is flared, helps to project the sound from the speaker. Thus, in the example shown, right speaker 304 is shown mounted to right speaker mounting bracket 600 in recess 604. This may be seen more clearly in FIG. 7, which is an oblique view of right speaker mounting bracket 600 showing right speaker 304 is shown mounted to right speaker mounting bracket 600 in recess 604. This may also be seen in FIG. 8, which is an oblique cross-sectional view of the speaker system 100, showing right speaker 304, left speaker 302, right speaker mounting bracket 600, left speaker mounting bracket 800, left speaker cover 802, and right speaker cover 804. Also shown are right speaker enclosure cavity 806 and left speaker enclosure cavity 808.

In one embodiment, the size of add-on speaker system 100, and correspondingly, the sizes of speaker mounting brackets 600, 800, are sufficient to mount relatively large speakers. For example, speakers such as 6×9 inch speakers may be accommodated in add-on speaker system 100. Likewise, other large speaker sizes may be accommodated depending upon the dimensions of add-on speaker system 100. Thus, there may be embodiments in which circular speakers having diameters of approximately 8 inches, 10 inches, 12 inches, and 15 inches may be accommodated. Likewise, there may be embodiments in which smaller circular speakers having diameters of approximately 6 inches or 4 inches may be accommodated. Such speakers provide greatly improved audio performance over the tiny speakers included in portable media players, and over the small speakers included in conventional add-on speaker systems. Examples of improved audio performance may include increased power-handling capability, and thus, increased performance volume, as well as increased bass response.

Speakers of the sizes discussed above may include two-way or three-way speakers. Speakers referred to as two-way or three-way speakers are examples of multi-way speakers, which are actually speaker systems made up of multiple speaker drivers, each covering a different audio frequency band. A two-way speaker comprises two speaker drivers, such as a woofer covering bass audio frequencies, and a mid-range/tweeter covering mid-range and high audio frequencies. Likewise, a three-way speaker comprises three speaker drivers, such as a woofer covering bass audio frequencies, a mid-range covering mid-range audio frequencies, and a tweeter covering high audio frequencies. There are no universal definitions of the precise frequencies that are included in the bass, mid-range, and high frequencies. Rather, the precise frequencies involved depend upon the engineering decisions made in the design of each particular speaker and speaker driver. Examples of typical frequency values may include: bass below about 80 Hz-300 Hz, mid-range—from about 80 Hz-300 Hz to about 3000 Hz-5000 Hz, and high frequencies—above about 3000 Hz-5000 Hz.

Some multi-way speakers have the electrical leads of all of the included speaker drivers connected in parallel. This is the least expensive connection technique, but this causes all frequencies of the applied audio signal to be presented to all of the speaker drivers. An improved connection technique involves the use of a crossover. A crossover is a type of electronic filter that is used to direct the bass, mid-range, and high frequencies to the corresponding speaker driver. The edges of the bass, mid-range, and high frequencies frequency ranges are known as the crossover frequencies. Connection using a crossover generally results in improved audio performance of the speakers.

In addition, although not shown, right speaker enclosure cavity 806 and left speaker enclosure cavity 808 may be contain some acoustic foam. This acoustic foam may provide improved audio characteristics. The amount of acoustic foam may be varied depending upon the desired audio characteristics. In addition, the remainder of the interior spaces of the system enclosure may be filled with acoustic foam, insulating foam, or dual purpose foam.

Examples of acoustic foam may include polyurethane foam, polyether foam, polyethylene foam, polyester foam, polyvinyl chloride foam, and melamine foam. Many of these types of foam also have thermal insulating properties and may be used to provide thermal insulation as well.

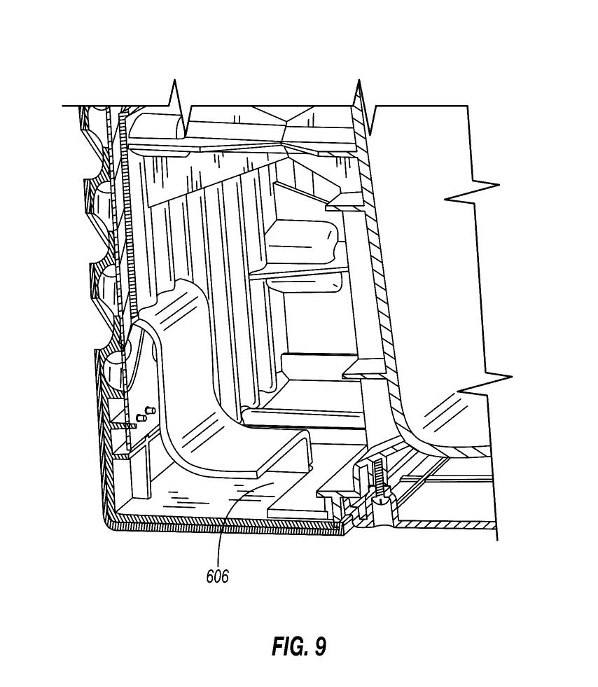

Returning now to FIG. 6, an acoustic port 606 is shown in right speaker mounting bracket 600. Acoustic port 606 may also provide improved audio characteristics, such as increased bass response. Such an acoustic port may be provided in both the left and right speaker mounting brackets. An exemplary more detailed view of an acoustic port 606 is shown in FIG. 9.

In one embodiment, each speaker mounting bracket, together with the speaker system enclosure and acoustic port may form a bass reflex speaker system. Bass reflex speaker systems may use the acoustic energy emitted from the rear side of the speaker diaphragm to increase the efficiency of the system at low frequencies as compared to a typical speaker system. In a bass reflex speaker system, an acoustic port performs as a reflex port to enhance the reproduction of bass frequencies generated by the bass or woofer portion of the speaker.

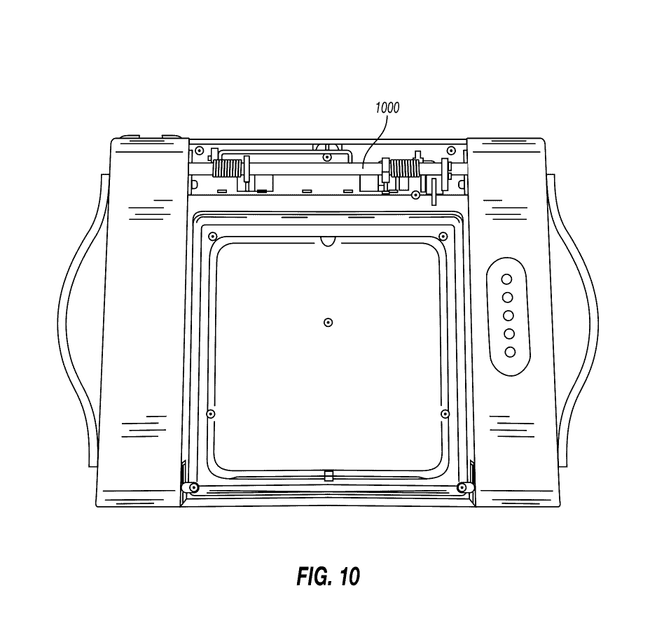

An exemplary view of an embodiment of a storage compartment cover hinge is shown in FIG. 10. Hinge 1000 provides the capability for storage compartment cover 108 (not shown) to open and close. In this example, hinge 1000 is spring-loaded, to provide smooth and consistent operation of storage compartment cover 108.

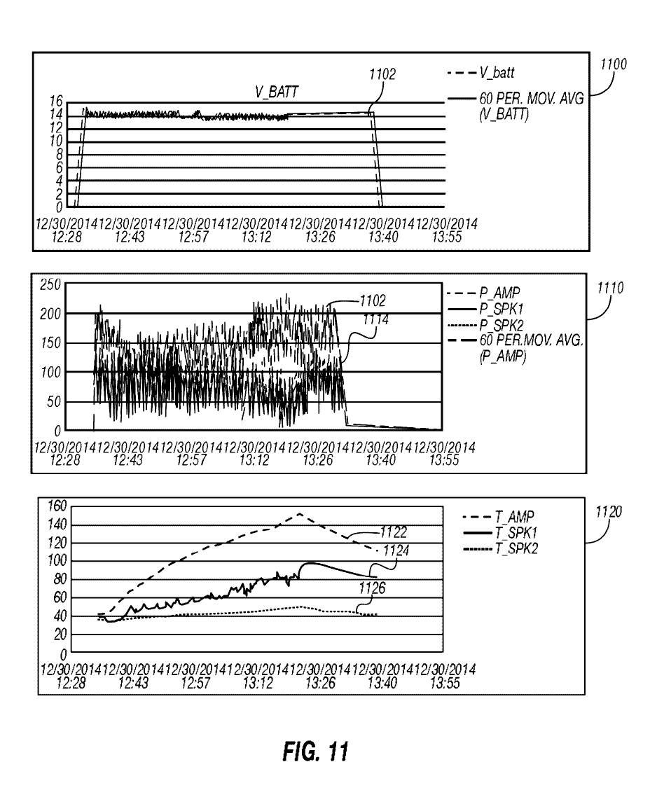

An example of performance testing results of an embodiment of the present invention is shown in FIG. 11. Chart 1100 shows an example of battery voltage performance. It can be seen that the battery voltage 1102 holds up well, both during operation and after operation of the add-on speaker system. Such performance is due to a combination of factors, including battery parameter selection, amplifier selection, speaker selection, etc. Chart 1110 shows an example of power usage by components of the add-on speaker system. For example, the audio power amplifier power usage 1112 ranges from near 100 watts to almost 200 watts. Likewise, the speaker power usage 1114 of each speaker ranges from near 50 watts to almost 100 watts. Such power handling is greatly in excess of that of a typical conventional add-on speaker system. Further, chart 1120 shows the temperatures of components of the add-on speaker system. For example, the audio power amplifier temperature 1122 maintains a relatively constant temperature near the ambient temperature of around 40° C. The speaker 1 (Left speaker) temperature 1124 ranges from an ambient of around 40° C. to almost 100° C. Likewise, the speaker 2 (Right speaker) temperature 1126 ranges from an ambient of around 40° C. to around 150° C. These operational temperatures are greatly in excess of the operational temperatures of a typical conventional add-on speaker system.

Further details of the acoustic port 606 will be given with reference to FIGS. 6-7. As will be understood by those of skill in the art, the speaker enclosure 604 is a bass reflex system. That is, the speaker enclosure 604 is designed so as to use the sound from the rear side of the diaphragm of the speaker 304 to increase the quality and volume of sound produced at low audio frequencies as compared to other types of speaker enclosure, such as closed boxes or those employing infinite baffle mounting.

A distinguishing characteristic of such a bass reflex system is the presence of an acoustic port 606 in the speaker enclosure 604. The air mass in the acoustic port resonates with the movement of the air inside the speaker enclosure 604, ultimately producing higher output for a given excursion of the speaker 304 compared to a closed box design, or producing a similar output to a closed box design but with a smaller excursion of the speaker 304.

Such acoustic ports 606 are typically formed toward the middle of the speaker enclosure 604 (with respect to the top and bottom of the speaker enclosure 604). However, if the speaker enclosure 604 is operated in the proximity of water or moisture, such as near a swimming pool or body of water, splashing or other means could cause the entrance of water into the speaker enclosure 604 via way of the acoustic port 606. This water would be unable to exit the speaker enclosure 604 and would ultimately collect at the bottom of the speaker enclosure 604, causing both acoustic issues as well as potentially causing electronic issues by causing a short to electronic components within the speaker enclosure 604. Moreover, this water could cause corrosion of the speaker enclosure 604.

To avoid these potential deleterious effects, and to enable use of the speaker enclosure 604 in the proximity of water, the acoustic port 606 is formed adjacent the bottom of the speaker enclosure 604. This way, any water that enters the speaker enclosure 604 via the acoustic port 606 is able to flow back out through the acoustic port 606 instead of collecting. In addition, the acoustic port 606 is formed so as to fire outward from the speaker enclosure 604 rather than downward, which could result in distorted and muffled sound.

The acoustic port 606, as perhaps best shown in FIG. 7, is defined in part by a recessed front wall recessed in the face of the speaker enclosure 604. The recessed front wall curves inwardly until the surface thereof faces the bottom of the speaker enclosure 604, and may even be parallel with the bottom of the speaker enclosure 604. The acoustic port 606 is defined in other part by the bottom of the speaker enclosure 604, such that air passes between the surface of the recessed front wall of the speaker enclosure 604 that is facing downwardly and the bottom of the speaker enclosure 604. Resultantly, as explained above, air exists from the acoustic port 606 outwardly and not downwardly. This provides for high quality and high volume sound production.

The acoustic port 606, defined as described above, is illustratively shown as being rectangular in cross section. However, it should be understood that the recessed front wall of the speaker enclosure 604 and the bottom of the speaker enclosure 604 may be shaped differently such that the acoustic port 606 takes any shape, such as having a square, circular, or oval cross section.

It should be noted that the front of the speaker enclosure 604, as shown in FIGS. 6-7, is corrugated in shape, having a surface that defines hills and valleys. This corrugated shape provides for greater stiffness and increases structural strength than a smooth shaped surface would.

The corrugated shape of the front of the speaker enclosure 604 is not just defined by the outside surface of the front, but also by the inside surface of the front. Thus, the air moving within the speaker enclosure 604 interacts with the corrugations of the inside surface of the front of the speaker enclosure 604. In some cases, the corrugated shape of the front speaker enclosure 604 may be on the inside surface of the front and not on the outside surface of the front. Also, in some cases, multiple walls of the speaker enclosure 604 may have a corrugated shape on an interior and/or exterior surface thereof.

The Inventors have found that, surprisingly, the corrugated shape defined by the inside surface of the front of the speaker enclosure 604 provides for enhanced sound and audio characteristics. As best understood by the Inventors, the corrugated shape reduces laminar flow of air thereacross, that is, air “sticks” to the corrugated surface as it flows across it, instead of flowing separate and spaced apart from a flat surface due to a boundary layer of area formed adjacent that flat surface. This results in turbulence in the air and reverberation inside the speaker enclosure 604, and decreases the incidence of “dead” or unmoving air.

Although the hills and valleys defined by the surfaces of the front of the speaker enclosure 604 are shown as being rounded, it should be understood that they may instead be triangular or sawtoothed in shape. In addition, although the size and spacing of the hills and valleys defined by the surfaces of the front of the speaker enclosure 604 as being consistent and equal, in some applications the various hills and valleys may be sized differently, spaced from one another differently, and in fact, different hills and valleys may take different shapes.

Shown in FIGS. 2, 4, and 8 are the speaker covers or grills 802, 804 as installed over the front of the speaker enclosures 604. The speaker grills 802, 804 have valleys 1200 defined in an outer surface thereof. These valleys 1200 illustratively are semi-cylindrical in cross section. Some valleys 1200 illustratively are shorter in length than other valleys 1200. In addition, the valleys 1200 illustratively extend diagonally across the speaker grills 802, 804, with the valleys 1200 on the speaker grill 802 and the valleys 1200 on the speaker grill 802 extending in opposite diagonal directions from one another.

Although the valleys 1200 are shown as extending diagonally across the speaker grills 802, 804, it should be understood they could extend horizontally or vertically as well. In addition, the valleys 1200 need not be semi-cylindrical in cross section, and indeed may have any cross sectional shape, such as rectangular or square. Also, different valleys 1200 may have different shapes, lengths, and widths.

The valleys 1200 have openings 1202 formed therein. The openings 1202 are parabolic in cross section and therefore serve to amplify the sound waves as they exit through the openings 1202. It should be understood that the openings 1202 may instead be conical in cross section, and that different openings 1202 may have different cross sectional shapes and may be sized differently.

It should also be appreciated that the valleys 1200 need not be present, and that the openings may be formed in the speaker grills 802, 804 regardless of the shape of the surfaces of the speaker grills, and that the openings may be parabolic in cross section, conical in cross section, a combination of both parabolic and conical, or any other suitable cross sectional shapes.

It should be understood that the general cross sectional shape of the speaker enclosures 604 is rectangular, with a height and width that both greatly exceed the depth. This allows for a compact speaker enclosure 604 that has a substantial internal volume, helping to provide for desirable acoustic characteristics. In addition, the placement of the speakers 302, 304 themselves within the speaker enclosures 604 is toward the top of the speaker enclosures 604, so as to reduce the likelihood of exposure of the speakers 302, 304 to water.

Although examples of embodiments of the present invention have been described, it will be understood by those of skill in the art that there are other embodiments that are nonetheless within the scope of the present invention. For example, parameters including, but not limited to any dimensions of the add-on speaker system enclosure or components thereof, dimensions, power handling characteristics, temperature characteristics, and multi-way characteristics of the speakers, frequency ranges of the speaker or speaker drivers, power handling characteristics and frequency characteristics of the audio power amplifier, power handling characteristics and frequency characteristics of the crossovers, voltage and capacity of the battery, chemical composition and distribution of acoustic and/or insulating foam, presence, dimensions, and placement of acoustic port, and any others described above, are all contemplated by the present invention. Accordingly, it is to be understood that the invention is not to be limited by the specific described embodiments, but only by the scope of the appended claims.

What is claimed is:

1. A speaker system comprising:
at least one speaker enclosure comprising a wall having an acoustic port formed therein and toward a bottom thereof, the acoustic port being shaped such that air exiting the acoustic port flows outwardly in a direction parallel to a bottom of the wall;
wherein the wall of the at least one speaker enclosure is shaped so as to define a plurality of hills and valleys on an inwardly facing surface thereof; and
a grill positioned over the wall of the at least one speaker enclosure, the grill having a plurality of holes defined therein, the plurality of holes having parabolic shaped cross sections.

2. The speaker system of claim 1, wherein the plurality of valleys have semi-cylindrical shaped cross sections.

3. The speaker system of claim 1, wherein the at least one speaker enclosure is also shaped so as to define a plurality of hills and valleys on at least one outwardly facing surface thereof.

4. The speaker system of claim 1, wherein the acoustic port is formed toward a bottom of the at least one speaker enclosure.

5. The speaker system of claim 1, wherein the grill is shaped so as to define a plurality of valleys on an outwardly facing surface thereof, wherein plurality of holes are defined in the plurality of valleys.

6. A speaker system comprising:
at least one speaker enclosure;
wherein the at least one speaker enclosure is shaped so as to define a plurality of hills and valleys on at least one inwardly facing surface thereof.

7. The speaker system of claim 6, wherein the at least one speaker enclosure is also shaped so as to define a plurality of hills and valleys on at least one outwardly facing surface thereof.

8. The speaker system of claim 6, wherein the at least one speaker enclosure comprises a front wall; and wherein the plurality of hills and valleys are defined on the inwardly facing surface of the front wall.

9. The speaker system of claim 6, wherein the at least one speaker enclosure has an acoustic port formed therein toward a bottom thereof, the acoustic port being shaped such that air exiting the acoustic port flows outwards in a direction parallel to the bottom.

10. The speaker system of claim 9, wherein the acoustic port has a rectangular cross section.

11. The speaker system of claim 6, further comprising a grill positioned over a portion of the at least one speaker enclosure, the grill being shaped so as to define a plurality of valleys on at least one surface thereof, the plurality of valleys having semi-cylindrical shaped cross sections.

12. The speaker system of claim 11, wherein the grill is shaped so as to define the plurality of valleys on an outer surface thereof

13. The speaker system of claim 11, wherein the plurality of valleys defined by the grill have a plurality of holes defined therein, at least some of the plurality of holes having parabolic shaped cross sections.

14. The speaker system of claim 11, wherein the plurality of valleys extend diagonally across the grill.

15. The speaker system of claim 1, further comprising a grill positioned over a portion of the at least one speaker enclosure, the grill having a plurality of holes defined therein, at least some of the plurality of holes having parabolic shaped cross sections.

16. The speaker system of claim 6, wherein the at least one speaker enclosure is generally rectangular in shape, having a height and width greater than its depth.

17. A speaker system comprising:
at least one speaker enclosure comprising a wall having an acoustic port formed therein and toward a bottom thereof, the acoustic port being shaped such that air exiting the acoustic port flows outward in a direction parallel to the bottom.

18. The speaker system of claim 17, wherein the wall of the at least one speaker enclosure is shaped so as to define a plurality of hills and valleys on an inwardly facing surface thereof.

19. The speaker system of claim 17, wherein the wall of the at least one speaker enclosure is also shaped so as to define a plurality of hills and valleys on an outwardly facing surface thereof.

20. The speaker system of claim 17, wherein the at least one speaker enclosure is generally rectangular in shape, having a height and width greater than its depth.

21. A speaker system comprising:
at least one speaker enclosure; and
a grill positioned over at least a portion of the at least one speaker enclosure;
wherein the grill has a plurality of holes defined therein, the plurality of holes having parabolic shaped cross sections.

22. The speaker system of claim 21, wherein the grill is shaped so as to define a plurality of valleys on an outwardly facing surface thereof, the plurality of valleys having semi-cylindrical shaped cross sections; and wherein ones of the plurality of holes are formed within respective ones of the plurality of valleys.
